(19) United States
(12) Patent Application Publication
(10) Pub. No.: US 2024/0353959 A1
(43) Pub. Date: Oct. 24, 2024

(54) TOUCH DETECTION AND FEEDBACK SYSTEM AND METHOD

(71) Applicant: GOERTEK INC., Weifang, Shandong (CN)

(72) Inventor: Bo LIANG, Weifang, Shandong (CN)

(21) Appl. No.: 18/580,728

(22) PCT Filed: Jul. 21, 2022
(86) PCT No.: PCT/CN2022/107044

§ 371 Date: Jan. 19, 2024

(30) Foreign Application Priority Data
Jul. 23, 2021 (CN) 202110841378.4

(51) Int. Cl. G06F 3/043; G06F 3/01

(52) U.S. Cl. CPC G06F 3/0436; G06F 3/016

(57) ABSTRACT

Disclosed is a touch detection and feedback system and method. The touch detection and feedback system includes a housing, an ultrasonic transmitting terminal, an ultrasonic receiving terminal, a feedback output element, and a main control unit, a mounting cavity is provided in the housing, and the mounting cavity is a closed space; the ultrasonic transmitting terminal, the ultrasonic receiving terminal, and the feedback output element are all provided in the mounting cavity; the ultrasonic transmitting terminal, the ultrasonic receiving terminal, and the feedback output element are electrically connected to the main control unit, separately.

The present application claims the priority to the Chinese Patent Application No. 202110841378.4, entitled “TOUCH DETECTION AND FEEDBACK SYSTEM AND METHOD” filed with China Patent Office on Jul. 23, 2021, the entire contents of which are incorporated into the present disclosure by reference.

### TECHNICAL FIELD

The present disclosure relates to a technical field of touch detection, and more particularly, to a touch detection and feedback system and method.

### DESCRIPTION OF RELATED ART

At present, touch detection schemes in the market are mainly capacitive touch schemes. Pressure-sensitive button technology is currently gradually penetrating and replacing capacitive touch schemes. A main improvement direction is to avoid the risk of touch by mistake and to enhance user experience. However, one disadvantage of pressure-sensitive button technology is that a certain amount of deformation is necessary to be produced on a housing to be transmitted to a pressure sensor so as to produce a change in resistance or inductance. For some application scenarios with metal housing, there is a risk of reduced sensitivity or even failure due to small deformation.

### SUMMARY

The present disclosure provides a touch detection and feedback system and method, solves the problem of touch by mistake of a capacitive key and reduces the risk of reduced sensitivity or even failure of a piezoelectric key caused by a deformation factor, achieves identification of various touch operations such as non-touch, tap, and pressing, achieves output of multiple levels of feedback signal for different touch forces, and reduces the influence of a vibration feedback element on a touch detection element by a method that touch detection and vibration feedback are not performed at the same time.

In order to achieve the above object, the present disclosure provides a touch detection and feedback system including:
a housing having a mounting cavity provided therein, the mounting cavity being a closed space;
an ultrasonic transmitting terminal provided in the mounting cavity;
an ultrasonic receiving terminal provided in the mounting cavity;
a feedback output element provided in the mounting cavity; and
a main control unit electrically connected to the ultrasonic transmitting terminal the ultrasonic receiving terminal, and the feedback output.

Optionally, the touch detection and feedback system further includes:
a substrate covering an opening provided on the housing and communicating with the mounting cavity, wherein the ultrasonic transmitting terminal, the ultrasonic receiving terminal, and the feedback output element are provided on the substrate, and the substrate is electrically connected to the main control unit.

Optionally, the main control unit includes:
a processor electrically connected to the ultrasonic transmitting terminal and the feedback output element;
an operational amplifier circuit electrically connected to the ultrasonic receiving terminal; and
a peak envelope detection circuit electrically connected between the operational amplifier circuit and the processor.

Optionally, the main control unit further includes:
an ultrasonic driving chip electrically connected between the processor and the ultrasonic transmitting terminal.
optionally, the feedback output element is a piezoelectric motor; and the main control unit further includes:
a piezoelectric motor drive chip electrically connected between the processor and the piezoelectric motor.

In order to achieve the above object, the present disclosure further provides a touch detection and feedback method, which is applied to the touch detection and feedback system as described above, including:
transmitting, by the ultrasonic transmitting terminal, ultrasonic signals;
receiving, by the ultrasonic receiving terminal, the ultrasonic signals reflected from the housing; and
controlling, according to different amplitudes of the received ultrasonic signals, the feedback output element to output different feedback signals.

Furthermore, the feedback output element is a piezoelectric motor; and controlling, according to different amplitudes of the received ultrasonic signals, the feedback output element to output different feedback signals includes:
if the amplitude of the received ultrasonic signal is greater than a first preset threshold, controlling the piezoelectric motor not to generate a vibration signal;
if the amplitude of the received ultrasonic signal is less than the first preset threshold and greater than a second preset threshold, controlling the piezoelectric motor to generate a first vibration signal; and
if the amplitude of the received ultrasonic signal is less than the second preset threshold, controlling the piezoelectric motor to generate a second vibration signal.

Furthermore, the feedback output element is a piezoelectric motor; and controlling, according to different amplitudes of the received ultrasonic signals, the feedback output element to output different feedback signals includes:
controlling, based on a corresponding relationship between the amplitude of the ultrasonic signal and a driving voltage of the piezoelectric motor when the amplitude of the received ultrasonic signal changes, the piezoelectric motor to generate a corresponding vibration signal.

Furthermore, receiving, by the ultrasonic receiving terminal, the ultrasonic signals reflected from the housing includes:
controlling an analog-to-digital conversion channel to be turned on;
receiving, through the analog-to-digital conversion channel, the ultrasonic signal collected by the ultrasonic receiving terminal; and
controlling the analog-to-digital conversion channel to be turned off.

Furthermore, controlling, according to different amplitudes of the received ultrasonic signals, the feedback output element to output different feedback signals is performed after receiving, by the ultrasonic receiving terminal, the ultrasonic signals reflected from the housing is finished.

One or more technical solutions provided in the present disclosure have at least the following technical effects or advantages:

According to the technical solution of the present disclosure, the main control unit transmits, by the ultrasonic transmitting terminal, ultrasonic signals, and receives, by the ultrasonic receiving terminal, the ultrasonic signals reflected from the housing. Based on the principle that different acoustic impedances between the housing, the air and the human body cause changes in the ultrasonic reflection waveform, the present disclosure can achieve identification of various touch operations such as non-touch, tap, and pressing, can achieve output of multiple levels of feedback signal for different touch forces through the feedback output element so as to achieve the purpose of interacting with the user, thereby enhancing user experience. The present disclosure may solve the problem of touch by mistake of a capacitive key and reduces the risk of reduced sensitivity or even failure of a piezoelectric key caused by a deformation factor, and reduces the influence of a vibration feedback element on a touch detection element by a method that touch detection and vibration feedback are not performed at the same time.

### BRIEF DESCRIPTION OF DRAWINGS

In order to more clearly illustrate the embodiments of the present disclosure or the technical solutions in the prior art, the drawings required to be used for the description of the embodiments or the prior art will be briefly introduced in the following. Obviously, the drawings in the following description are merely some embodiments of the present disclosure, and for those of ordinary skill in the art, other drawings can also be obtained based on the structures illustrated in the provided drawings without any creative effort.

FIG. 1 is a schematic structural diagram of a touch detection and feedback system according to an embodiment of the present disclosure;

FIG. 2 is a schematic diagram of a circuit module of the touch detection and feedback system of FIG. 1;

FIG. 3 is a schematic structural diagram of the touch detection and feedback system of FIG. 1 in a non-touch state;

FIG. 4 is a schematic structural diagram of the touch detection and feedback system of FIG. 1 in a tap state;

FIG. 5 is a schematic structural diagram of the touch detection and feedback system of FIG. 1 in a pressing state;

FIG. 6 is a schematic flow chart of a first embodiment of a touch detection and feedback method of the present disclosure;

FIG. 7 is a schematic flow chart of detailed steps of step S30 in a second embodiment of the touch detection and feedback method of the present disclosure;

FIG. 8 is a schematic flow chart of a third embodiment of a touch detection and feedback method of the present disclosure;

FIG. 9 is a schematic flow chart of detailed steps of step S20 in a fourth embodiment of the touch detection and feedback method of the present disclosure;

FIG. 10 is a schematic diagram of the timing control of an ultrasonic transmitting terminal, an ultrasonic receiving terminal and a piezoelectric motor in the touch detection and feedback system.

The reference numbers in the drawings are follows:

| Number | Name |
|---|---|
| 100 | touch detection |
| | and feedback |
| | system |
| 10 | housing |
| 11 | mounting cavity |
| 20 | ultrasonic |
| | transmitting |
| | terminal |
| 30 | ultrasonic |
| | receiving terminal |
| 40 | piezoelectric |
| | motor |
| 50 | main control |
| | unit |
| 51 | processor |
| 52 | primary operational |
| | amplifier |
| | circuit |
| 53 | secondary operational |
| | amplifier |
| | circuit |
| 54 | peak envelope |
| | detection |
| | circuit |
| 55 | ultrasonic driving |
| | chip |
| 56 | piezoelectric |
| | motor drive chip |
| 60 | substrate |

The realization of objects, functional features and advantages of the present disclosure will be further described in conjunction with the embodiments and with reference to the accompanying drawings.

### DETAILED DESCRIPTIONS

In order to better understand the above technical solutions, exemplary embodiments of the present disclosure will be described in more detail below with reference to the accompanying drawings. Although exemplary embodiments of the present disclosure are illustrated in the drawings, it should be understood that the present disclosure may be implemented in various forms and should not be limited to the embodiments set forth herein. Rather, these embodiments are provided to provide a thorough understanding of the disclosure, and to fully convey the scope of the disclosure to those skilled in the art.

In order to better understand the above technical solutions, the above technical solutions will be described in detail below with reference to the accompanying drawings and specific implementations.

The present disclosure provides a touch detection and feedback system 100.

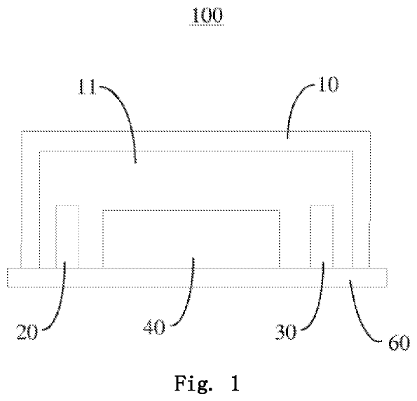

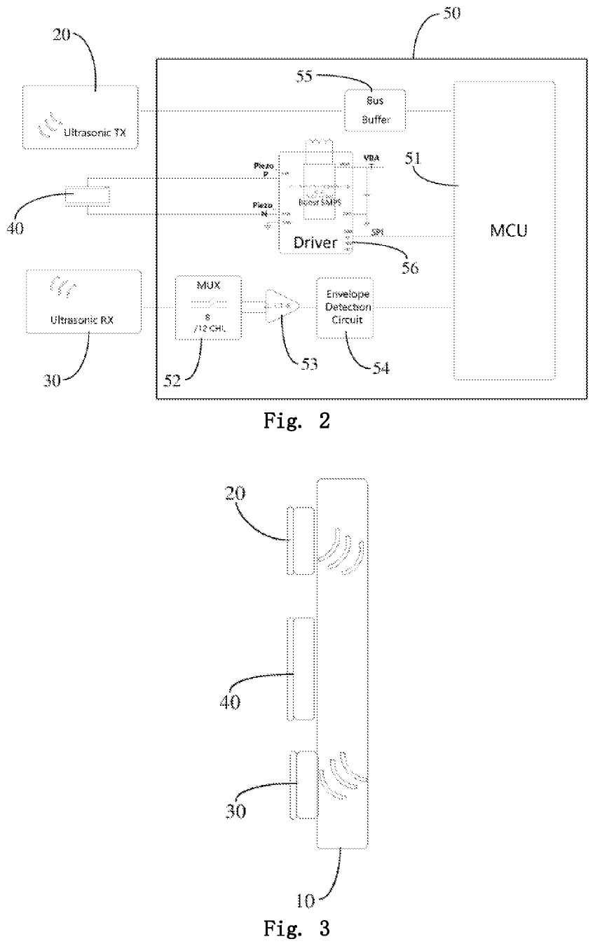

In an embodiment of the present disclosure, as illustrated in FIGS. 1 and 2, the touch detection and feedback system 100 includes a housing 10, an ultrasonic transmitting terminal 20, an ultrasonic receiving terminal 30, a feedback output element, and a main control unit 50, a mounting cavity 11 is provided in the housing 10, and the mounting cavity 11 is a closed space; the ultrasonic transmitting terminal 20, the ultrasonic receiving terminal 30, and the feedback output element are all provided in the mounting cavity 11; the ultrasonic transmitting terminal 20, the ultrasonic receiving terminal 30, and the feedback output element are electrically connected to the main control unit 50.

Specifically, the touch detection and feedback system 100 of the present disclosure may be applied to AR (Augmented Reality device), VR (Virtual Reality device), electronic watches, touch components of cars or other electronic devices that require touch detection and feedback. In terms of structural design, the ultrasonic transmitting terminal 20, the ultrasonic receiving terminal 30, and the feedback output element may be bonded and fixed to the housing 10 through hard adhesive, and at the same time, the housing 10 can protect the ultrasonic transmitting terminal 20, the ultrasonic receiving t terminal 30, and the feedback output element. The housing 10, the ultrasonic transmitting terminal 20, the ultrasonic receiving terminal 30 and the feedback output element form an integrated module, which has a compact structure and small size, with a volume of only 5.2 mm×5.2 mm×1.15 mm, can be easily installed in the applied electronic device. And, the main control unit 50 may be integrated on a main board of the electronic device, the main control unit 50 and the ultrasonic transmitting terminal 20, the ultrasonic receiving terminal 30 and the feedback output element may be connected through wires or flexible circuit board (FPC) to achieve circuit continuity. In order to facilitate the transmission and reception of ultrasonic signals, the ultrasonic transmitting terminal 20 and the ultrasonic receiving terminal 30 may be symmetrically installed on both sides of the feedback output element.

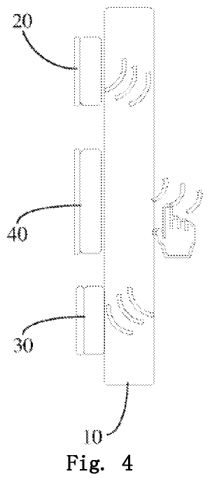

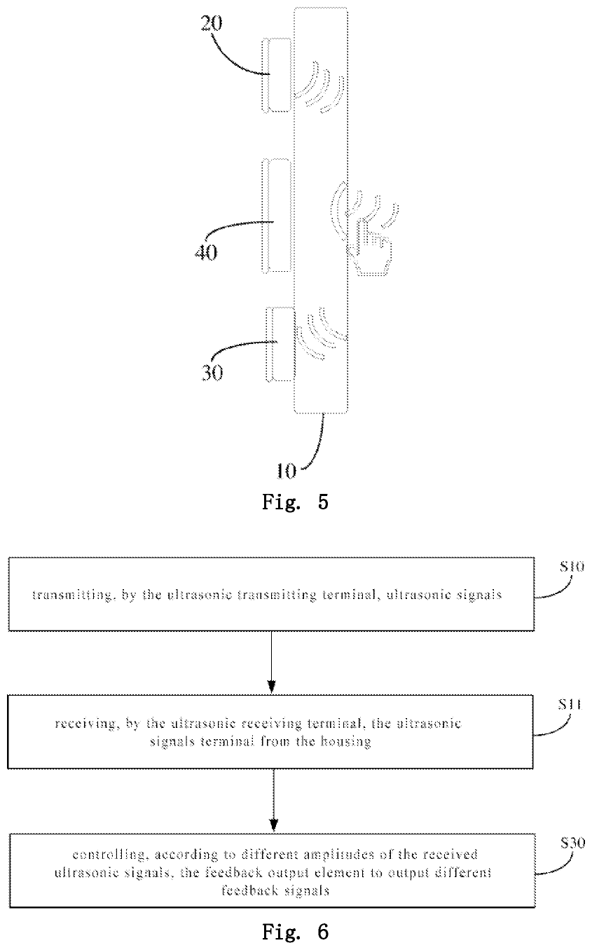

In the embodiment of the present disclosure, touch detection is implemented based on the principle that different acoustic impedances between the housing 10, the air and the human body cause changes in the ultrasonic reflection waveform. Specifically, referring to FIGS. 3-5, when detecting a touch operation, the main control unit 50 controls the ultrasonic transmitting terminal 20 to transmit ultrasonic signals. The ultrasonic signals spread from the ultrasonic transmitting terminal 20 toward the housing 10, are reflected by the housing 10 and then transmitted back, and are received by the ultrasonic receiving terminal 30. The housing has a closed structure, and the acoustic impedance of the air is significantly different from that of the solid material of housing 10; therefore, when the human body does not touch the housing 10, 99% reflection of the ultrasonic signals occurs in the housing 10 (taking a metal housing 10 as an example), and amplitudes of the ultrasonic signals received by the ultrasonic receiving terminal 30 are correspondingly relatively high; when the user's finger (human body) touches a surface of the housing 10, the acoustic impedance at an interface of the housing 10 and the air may change, part of the ultrasonic signals can spread outward through the finger, and an energy of the reflected ultrasonic signals may be reduced to 82% of that of the ultrasonic signals before reflection, that is, amplitudes of the ultrasonic signals received by the ultrasonic receiving terminal 30 are attenuated; when the user's finger presses the housing 10 (either lightly or heavily), a contact surface between the lightly touching finger or the pressing finger with the housing 10 may have a small to large change, thus the energy of the ultrasonic signals propagating outward through the finger will also change from less to more. Then, the reflected ultrasonic signals will also form a changing trend from large to small, that is, the amplitudes of the ultrasonic signals received by the ultrasonic receiving terminal 30 are more attenuated. Therefore, the main control unit 50 can detect corresponding touch actions (including at least non-touch, tap, and pressing, etc.) by detecting the energy (amplitudes) of the reflected ultrasonic signals, thereby achieving multi-level force touch detection.

Meanwhile, based on the above detection results, the main control unit 50 can also control the feedback output element to generate feedback information corresponding to the touch action, so as to provide the user with corresponding operation feedback and realize information interaction between the system of the present disclosure and the user. The feedback output element may be a piezoelectric motor 40, and the piezoelectric motor 40 can generate a variety of different vibration modes to match different touch operations. Of course, the feedback output element may also be other types of electronic components, such as light emitting device (LED) light. The LED light is installed in the mounting cavity 11 of the housing 10 and the LED light is exposed from a surface of the housing 10, and the feedback effect can also be achieved by generating different light signals through the LED light. As another example, it may be a speaker, the purpose of feedback can be achieved by generating different acoustic signals through the speaker. The specific type of feedback output element is not limited in the present disclosure, and it can be set according to actual needs.

In summary, the touch detection and feedback system 100 of the present disclosure can achieve identification of various touch operations such as non-touch, tap, and pressing, and can achieve output of multiple levels of feedback signal for different touch forces through the feedback output element so as to achieve the purpose of interacting with the user, thereby enhancing user experience. The present disclosure can overcome the problem of touch by mistake of a capacitive key and reduces the risk of reduced sensitivity or even failure of a piezoelectric key caused by a deformation factor.

In an embodiment, referring to FIG. 1, the touch detection and feedback system 100 further includes a substrate 60. The substrate 60 covers an opening of the housing 10, which is provided on the housing 10 and communicates with the mounting cavity 11. The ultrasonic transmitting terminal 20, the ultrasonic receiving terminal 30, and the feedback output element are provided on the substrate 60, and the substrate 60 is electrically connected to the main control unit 50.

Specifically, the opening is provided on one surface of the housing 10, and a circuit board of corresponding size may be used as the substrate 60. The ultrasonic transmitting terminal 20, the ultrasonic receiving terminal 30 and the feedback output element are connected to the substrate 60, and then the substrate 60 is inverted and covered at the opening and is fixed with the housing 10, so that the ultrasonic transmitting terminal 20, the ultrasonic receiving terminal 30 and the feedback output element are installed into the mounting cavity 11 of the housing 10, and the mounting cavity 11 of the housing 10 forms a closed space. The substrate 60 may be electrically connected to the main control unit 50 provided on a main board of the applied electronic device through wires or FPC. Through the assembly structure of the housing 10 and the substrate 60, the installation, maintenance or parts replacement of the ultrasonic transmitting terminal 20, the ultrasonic receiving terminal 30 and the feedback output element can be facilitated.

In an embodiment, referring to FIG. 2, the main control unit 50 includes a processor 51, an operational amplifier circuit and a peak envelope detection circuit 54. The processor 51 is electrically connected to the ultrasonic transmitting terminal 20, and the processor 51 is electrically connected to the feedback output element; the operational amplifier circuit is electrically connected to the ultrasonic receiving terminal 30; and the peak envelope detection circuit 54 is electrically connected between the operational amplifier circuit and the processor 51.

Specifically, the processor 51 may be a micro control unit (MCU), which can coordinate the work between various electronic components. The processor 51 is configured to generate a control signal to drive the ultrasonic transmitting terminal 20 to transmit ultrasonic signals at a certain frequency; the ultrasonic signals received by the ultrasonic receiving terminal 30 are processed by the operational amplifier circuit and the peak envelope detection circuit and then sent to an analog-to-digital conversion (ADC) channel of the processor 51 for logical operations; when a finger touch is detected, according to a magnitude of the touch force, the processor 51 drives the feedback output element to output a corresponding feedback signal. Here, the operational amplifier circuit includes two-stage operational amplifier circuit (primary operational amplifier circuit and secondary operational amplifier circuit), can realize amplification and band-pass filtering of mV-level ultrasonic signals received by the ultrasonic receiving terminal 30; the peak envelope detection circuit 54 can realize the pre-processing of the output signal of the operational amplifier circuit, and envelop the peak value of sine wave signals with different amplitudes, which helps the ADC of the processor 51 to quickly detect voltage changes and reduces the requirement for ADC slew rate of the processor 51; the analog-to-digital conversion channel can convert an analog signal into a digital signal to realize data collection, so that the processor 51 can perform threshold detection and algorithm processing to analyze and determine the force level of the touch operation. The specific circuit structure settings of the operational amplifier circuit and the peak envelope detection circuit 54 can adopt conventional technology, and it will not be duplicated herein.

In an embodiment, referring to FIG. 2, the main control unit 50 includes an ultrasonic driving chip 55, and the ultrasonic driving chip 55 is electrically connected between the processor 51 and the ultrasonic transmitting terminal 20.

Specifically, the ultrasonic driving chip 55 is connected to positive and negative electrodes of the ultrasonic transmitting terminal 20. The ultrasonic driving chip 55 serves as a bus buffer and can improve the driving capability of the processor 51. The ultrasonic driving chip 55 controls the ultrasonic transmitting terminal 20 to open a transmitting channel and then transmit ultrasonic pulse driving signals, thereby controlling the ultrasonic transmitting terminal 20 to transmit ultrasonic signals according to a set frequency. As such, rising edge pulse glitches of the transmitted ultrasonic signal can be improved so that a stable ultrasonic signal can be formed. Of course, if the driving capability of the processor 51 is sufficient, the ultrasonic driving chip 55 can be omitted.

In an embodiment, referring to FIG. 2, the feedback output element is a piezoelectric motor 40; the main control unit 50 further includes a piezoelectric motor drive chip 56 electrically connected between the processor 51 and the piezoelectric motor 40.

Specifically, the piezoelectric motor drive chip 56 may be connected to the piezoelectric motor 40 through an serial peripheral interface (SPI) (either inter-integrated circuit (I2C) or SPI is acceptable, and the SPI bus with a faster transmission speed may be preferably used), and the piezoelectric motor 40 can achieve various modal vibration effects under the driving of the pulse waveform of piezoelectric motor drive chip 56, so as to provide corresponding amplitude feedback to match different touch forces and meet the feedback needs of different touch forces. As such, when the processor 51 detects a finger touch and recognizes the force level, the processor 51 will drive the piezoelectric motor 40 through the piezoelectric drive chip (piezoelectric drive integrated circuit (IC)) to generate local vibration and output feedback information to the user. The present disclosure uses a piezoelectric motor 40 made of piezoelectric ceramics, that is, a piezoelectric ceramic dielectric material is placed between two copper circular electrodes. When an alternating current (AC) audio signal is transmitted to the two electrodes, the piezoelectric plate may vibrate according to the magnitude and frequency of the signal. Compared to a linear resonance motor or an eccentric rotor motor, the piezoelectric motor 40 is smaller and lighter, which is conducive to realizing small-scale modularization of products. Compared to optical signal feedback or sound signal feedback, vibration feedback can achieve a click feel and deep touch effect similar to physical buttons, which is beneficial to improving user experience.

It should be noted that, in order to reduce the impact of the vibration feedback element, that is, the piezoelectric motor 40, on the signal received by the ultrasonic receiving terminal 30, the feedback output element is controlled to output different feedback signals after the ultrasonic receiving terminal 30 receives the ultrasonic signal transmitted back through the housing. It should be noted that the ultrasonic transmitting terminal 20 and the ultrasonic receiving terminal 30 can realize the driving and identification of ultrasonic energy, respectively, and both of them are also made based on piezoelectric ceramic sheets, but the ultrasonic device is different from the piezoelectric motor 40 in terms of shape, structural dimension, product packaging, usage, etc.

In an embodiment, the housing 10 is made of metal or plastic.

The housing 10 may be made of polycarbonate (PC) plastic, acrylonitrile butadiene styrene (ABS) plastic, stainless steel, carbon fiber or magnesium-aluminum alloy. Since the touch detection in the present disclosure does not rely on the deformation of the housing 10, a selection range of the material of the housing 10 is wider, and hard plastic or metal materials may be used to improve the impact resistance and wear resistance of the housing 10, and thus can prolong the service life of the housing 10 and effectively protect the ultrasonic transmitting terminal 20, the ultrasonic receiving terminal 30 and the feedback output element.

In order to achieve the above objective, the present disclosure also provides a touch detection and feedback method, which is applied to a touch detection and feedback system 100 including a housing 10, an ultrasonic transmitting terminal 20, an ultrasonic receiving terminal 30, a feedback output element, and a main control unit 50. A mounting cavity 11 is provided in the housing 10, and the mounting cavity 11 is a closed space; the ultrasonic transmitting terminal 20, the ultrasonic receiving terminal 30, and the feedback output element are all provided in the mounting cavity 11; the ultrasonic transmitting terminal 20, the ultrasonic receiving terminal 30, and the feedback output element are electrically connected to the main control unit 50. The main control unit 50 at least includes a processor 51, such as a central processing unit (CPU), a memory, and a communication bus. Here, the communication bus is used to realize connection communication between various components. The memory may be a high-speed random-access memory (RAM) or a non-volatile memory, such as s disk memory. The memory may optionally be a storage device independent of the aforementioned processor 51. The memory, as a storage medium, stores at least an application program for touch detection and feedback, and the processor 51 may be used to call the application program for touch detection and feedback stored in the memory and perform the following operations:
transmitting ultrasonic signals by the ultrasonic transmitting terminal 20;
receiving, by the ultrasonic receiving terminal 30, the ultrasonic signals reflected from the housing 10; and
controlling, according to different amplitudes of the received ultrasonic signals, the feedback output element to output different feedback signals.

Further, the processor 51 may call the application program for touch detection and feedback stored in the memory and perform the following operations:
if the amplitude of the received ultrasonic signal is greater than a first preset threshold, controlling the piezoelectric motor 40 not to generate a vibration signal;
if the amplitude of the received ultrasonic signal is less than the first preset threshold and greater than a second preset threshold, controlling the piezoelectric motor 40 to generate a first vibration signal; and
if the amplitude of the received ultrasonic signal is less than the second preset threshold, controlling the piezoelectric motor 40 to generate a second vibration signal.

An amplitude of the second vibration signal is greater than an amplitude of the first vibration signal.

Further, the processor 51 may call the application program for touch detection and feedback stored in the memory and perform the following operations:
when the amplitude of the received ultrasonic signal changes, controlling the piezoelectric motor 40 to generate a corresponding vibration signal based on a corresponding relationship between the amplitude of the ultrasonic signal and a driving voltage of the piezoelectric motor 40.

Further, the processor 51 may call the application program for touch detection and feedback stored in the memory and perform the following operations:

Receiving, by the ultrasonic receiving terminal 30, the ultrasonic signals reflected from the housing 10 includes:
controlling an analog-to-digital conversion channel to be turned on;
transmitting the ultrasonic signal received by the ultrasonic receiving terminal 30 to the analog-to-digital conversion channel; and
controlling an analog-to-digital conversion channel to be turned off.

Referring to FIG. 6, according to a first embodiment of the touch detection and feedback method provided by the present disclosure, the touch detection and feedback method includes:
S10: transmitting ultrasonic signals by the ultrasonic transmitting terminal 20;
S20: receiving, by the ultrasonic receiving terminal 30, the ultrasonic signals reflected from the housing 10; and
S30: controlling, according to different amplitudes of the received ultrasonic signals, the feedback output element to output different feedback signals.

In an embodiment of the present disclosure, specifically, referring to FIGS. 3-5, when detecting a touch operation, the main control unit 50 controls the ultrasonic transmitting terminal 20 to transmit an ultrasonic signals, the ultrasonic signals spread from the ultrasonic transmitting terminal 20 toward the housing 10, are reflected by the housing 10 and then transmitted back, and are received by the ultrasonic receiving terminal 30. The housing has a closed structure, and the acoustic impedance of the air is significantly different from that of the solid material of housing 10; therefore, when the human body does not touch the housing 10, 99% reflection of the ultrasonic signals occurs in the housing 10 (taking a metal housing 10 as an example), and amplitudes of the ultrasonic signals received by the ultrasonic receiving terminal 30 are correspondingly relatively high; when the user's finger (human body) touches a surface of the housing 10, the acoustic impedance at an interface of the housing 10 and the air may change, part of the ultrasonic signals can spread outward through the finger, and an energy of the reflected ultrasonic signals may be reduced to 82% of that of the ultrasonic signals before reflection, that is, amplitudes of the ultrasonic signals received by the ultrasonic receiving terminal 30 are attenuated; when the user's finger presses the housing 10 (either lightly or heavily), a contact surface between the lightly touching finger or the pressing finger with the housing 10 may have a small to large change, thus the energy of the ultrasonic signals propagating outward through the finger will also change from less to more. Then, the reflected ultrasonic signals will also form a changing trend from large to small, that is, the amplitudes of the ultrasonic signals received by the ultrasonic receiving terminal 30 are more attenuated. Therefore, the main control unit 50 can detect corresponding touch actions (including at least non-touch, tap, and pressing, etc.) by detecting the energy (amplitudes) of the reflected ultrasonic signals, thereby achieving multi-level force touch detection.

Meanwhile, based on the above detection results, the main control unit 50 can also control the feedback output element to generate feedback information corresponding to the touch action, so as to provide the user with corresponding operation feedback and realize information interaction between the system of the present disclosure and the user. The feedback output element may be a piezoelectric motor 40, and the piezoelectric motor 40 can generate a variety of different vibration modes to match different touch operations.

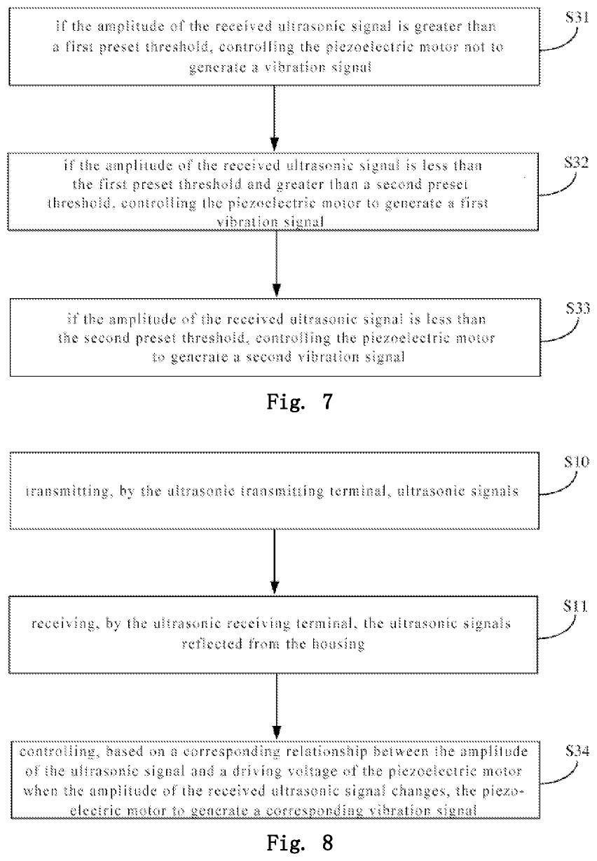

Further, based on the first embodiment, the present disclosure provides a second embodiment of the touch detection and feedback method. Referring to FIG. 7, in the second embodiment, the feedback output element is a piezoelectric motor 40, and the step S30 includes:
S31: if the amplitude of the received ultrasonic signal is greater than a first preset threshold, controlling the piezoelectric motor 40 not to generate a vibration signal;
S32: if the amplitude of the received ultrasonic signal is less than the first preset threshold and greater than a second preset threshold, controlling the piezoelectric motor 40 to generate a first vibration signal; and
S33: if the amplitude of the received ultrasonic signal is less than the second preset threshold, controlling the piezoelectric motor 40 to generate a second vibration signal.

Specifically, when performing vibration feedback, 2 to 3 thresholds may be set for simple touch recognition. For example, a first preset threshold with a larger amplitude and a second preset threshold with a smaller amplitude may be set, and by comparing the amplitude of the received ultrasonic signal and the first preset threshold and the second preset threshold, the touch operation may be identified as non-touch, tap, or pressing. According to different recognized touch operations, the piezoelectric motor 40 is controlled to output different vibration signals: when non-touch operation is recognized, the piezoelectric motor 40 is controlled not to vibrate; when a tap operation is recognized, the piezoelectric motor 40 is controlled to output a first vibration signal with a smaller amplitude; when a pressing operation is recognized, the piezoelectric motor 40 is controlled to output a second vibration signal with a larger amplitude; the amplitudes of the first vibration signal and the second vibration signal may be adjusted by changing a driving voltage of the piezoelectric motor 40. Of course, on this basis, the pressing operation may be further divided into light pressing, heavy pressing, etc. as needed, and relevant technical solutions fall within the protection scope of the present disclosure.

Further, based on the first embodiment, the present disclosure provides a third embodiment of the touch detection and feedback method. Referring to FIG. 8, in the third embodiment, the feedback output element is a piezoelectric motor 40, and the step S30 includes:

S34: when the amplitude of the received ultrasonic signal changes, controlling the piezoelectric motor 40 to generate a corresponding vibration signal based on a corresponding relationship between the amplitude of the ultrasonic signal and a driving voltage of the piezoelectric motor 40.

Specifically, when performing vibration feedback, the detected value of the ultrasonic signal may be used for force measurement, that is, a corresponding relationship between the amplitude of the ultrasonic signal and the driving voltage of the piezoelectric motor 40 can be established. As such, continuous detection of continuous changes in touch force can be achieved, a richer and more comprehensive touch force status is obtained, and corresponding continuously changing feedback information is output, thereby achieving a better feedback effect and further improving the user experience.

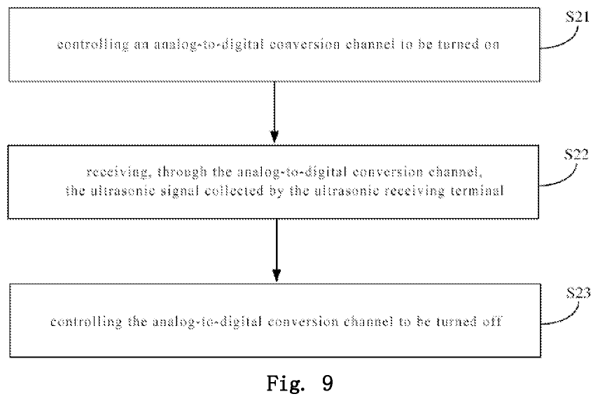

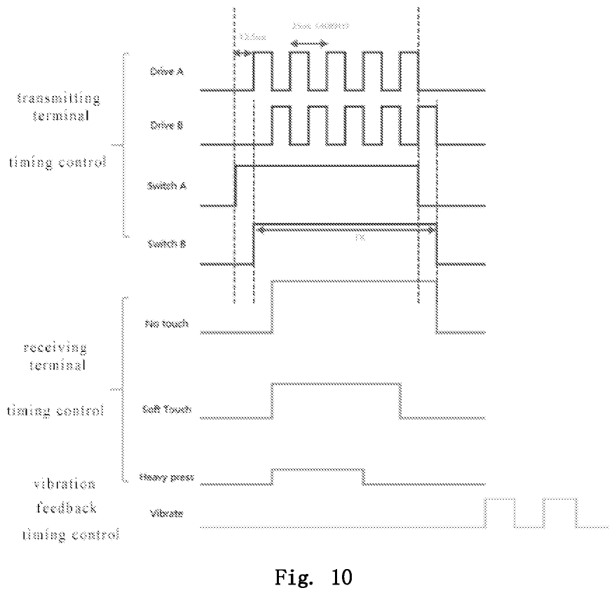

Further, based on the first to third embodiments, the present disclosure provides a fourth embodiment of the touch detection and feedback method. Referring to FIG. 9, in the fourth embodiment, the step S20 includes:
S21: controlling an analog-to-digital conversion channel to be turned on;
S22: receiving, through the analog-to-digital conversion channel, the ultrasonic signal collected by the ultrasonic receiving terminal 30; and
S23: controlling an analog-to-digital conversion channel to be turned off.

Specifically, when a piezoelectric motor 40 is used as the feedback output element, in order to prevent the vibration of the piezoelectric motor 40 from interfering with the reception of ultrasonic signals by the ultrasonic receiving terminal 30 and avoid the influence of the piezoelectric motor 40 on the ultrasonic receiving terminal 30, the touch detection step and the vibration feedback step adopt a time-sharing control method to ensure that the two steps are executed in a staggered manner in time, that is, the vibration feedback is performed after the ultrasonic receiving terminal 30 receives the ultrasonic signals. Specifically, when the ultrasonic transmitting terminal 20 transmits an ultrasonic signal, the analog-to-digital conversion (ADC) channel of the processor 51 can be turned on synchronously, so that the ultrasonic receiving terminal 30 can receive the ultrasonic signal reflected by the housing 10. After receiving the ultrasonic signal at the ultrasonic receiving terminal 30, the analog-to-digital conversion (ADC) channel of the processor 51 is turned off, and then the step of controlling the feedback element to output the feedback signal is performed. Here, an actual time between the transmission and reception of ultrasonic signals is between 1 and 2 ms, which may not affect touch detection; at the same time, the start-up time of the vibration of the piezoelectric motor 40 is about 5 ms, which is far lower than a time interval that can be distinguished by human body induction, which will not cause user experience problems.

Further, based on the first to third embodiments, the present disclosure provides a fifth embodiment of the touch detection and feedback method. Referring to FIG. 10, in the fifth embodiment, the step S30 is performed after the step S20 is completed.

Specifically, when a piezoelectric motor 40 is used as the feedback output element, in order to prevent the vibration of the piezoelectric motor 40 from interfering with the reception of ultrasonic signals by the ultrasonic receiving terminal 30 and avoid the influence of the piezoelectric motor 40 on the ultrasonic receiving terminal 30, the touch detection step and the vibration feedback step adopt a time-sharing control method to ensure that the two steps are executed in a staggered manner in time, that is, the vibration feedback is performed after the ultrasonic receiving terminal 30 receives the ultrasonic signals. Specifically, the processor 51 first controls the ultrasonic transmitting terminal 20 to transmit the ultrasonic signal through the ultrasonic driving chip 55, and then the processor 51 starts to receive the ultrasonic signal reflected by the housing 10 through the ultrasonic receiving terminal 30; after the ultrasonic receiving terminal 30 completes the reception of the ultrasonic signal, the processor 51 starts the piezoelectric motor 40 through the piezoelectric motor drive chip 56 to control the piezoelectric motor 40 to output a feedback signal. Through the above settings, the interference of vibration feedback on ultrasonic detection can be avoided, thereby ensuring the accuracy and reliability of ultrasonic detection.

Since the system introduced in the embodiments of the present disclosure is a system used to implement the method of the embodiments of the present disclosure, based on the method introduced in the embodiments of the present disclosure, those skilled in the art can understand the specific structure and modifications of the system, thus it will not be repeated here. Any system used in the method of the embodiments of the present disclosure belongs to the scope of protection intended by the present disclosure.

Those skilled in the art will understand that the embodiments of the present disclosure may be provided as method, system, or computer program product. Therefore, the present disclosure may take the form of an entirely hardware embodiment, an entirely software embodiment, or an embodiment that combines software and hardware. In addition, the present disclosure may take the form of a computer program product embodied on one or more computer-usable storage media (including, but not limited to, disk storage, compact disc (CD)-read only memory (ROM), optical storage, etc.) having computer-usable program codes.

The present disclosure is described with reference to flowchart illustrations and/or block diagrams of method, device (system), and computer program product. It will be understood that each process and/or block in the flowchart illustrations and/or block diagrams, and combinations of processes and/or blocks in the flowchart illustrations and/or block diagrams, can be implemented by computer program instructions. These computer program instructions may be provided to a controller of a general purpose computer, special purpose computer, embedded processor, or other programmable data processing devices to produce a machine, such that the instructions executed by the controller of the computer or other programmable data processing devices produce a device for realizing the functions specified in one or more processes of the flowchart and/or one or more blocks of the block diagram.

These computer program instructions may also be stored in a computer-readable memory that causes a computer or other programmable data processing devices to operate in a particular manner, such that the instructions stored in the computer-readable memory produce an article of manufacture including an instruction means, the instruction means implements the functions specified in one or more processes of the flowchart and/or one or more blocks of the block diagram.

These computer program instructions may also be loaded onto a computer or other programmable data processing devices, such that a series of operating steps can be performed on the computer or other programmable devices to produce computer-implemented processing, thus, instructions executed on the computer or other programmable devices provide steps for implementing functions specified in one or more processes of the flowchart and/or one or more blocks of the block diagram.

It should be noted that in the claims, any reference signs located between parentheses shall not be construed as a limitation on the claims. The term “include” does not exclude the presence of components or steps other than those listed in the claims. The word “a (an)” or “one” preceding a component does not exclude the presence of a plurality of such components. The present application may be implemented by means of hardware including several different components and by means of a suitably programmed computer. In the unit claims that list several elements, several of these elements may be embodied by the same item of hardware. The use of the words first, second, third, etc. does not indicate any order. These words can be interpreted as names.

Although preferred embodiments of the present disclosure have been described, those skilled in the art will be able to make additional changes and modifications to these embodiments once the basic inventive concepts are apparent. Therefore, it is intended that the appended claims be construed to include the preferred embodiments and all changes and modifications that fall within the scope of the present disclosure.

Obviously, those skilled in the art can make various modifications and variations to the present disclosure without departing from the spirit and scope of the present disclosure. In this way, if these modifications and variations of the present disclosure fall within the scope of the claims of the present disclosure and equivalent technologies, the present disclosure is also intended to include these modifications and variations.

1. A touch detection and feedback system, comprising:
a housing having a mounting cavity provided therein, the mounting cavity being a closed space;
an ultrasonic transmitting terminal provided in the mounting cavity;
an ultrasonic receiving terminal provided in the mounting cavity;
a feedback output element provided in the mounting cavity; and
a main control unit electrically connected to the ultrasonic transmitting terminal the ultrasonic receiving terminal, and the feedback output.

2. The touch detection and feedback system of claim 1, wherein the touch detection and feedback system further comprises:
a substrate covering an opening provided on the housing and communicating with the mounting cavity, wherein the ultrasonic transmitting terminal, the ultrasonic receiving terminal, and the feedback output element are provided on the substrate, and the substrate is electrically connected to the main control unit.

3. The touch detection and feedback system of claim 1, wherein the main control unit comprises:
a processor electrically connected to the ultrasonic transmitting terminal and the feedback output element;
an operational amplifier circuit electrically connected to the ultrasonic receiving terminal; and
a peak envelope detection circuit electrically connected between the operational amplifier circuit and the processor.

4. The touch detection and feedback system of claim 3, wherein the main control unit further comprises:
an ultrasonic driving chip electrically connected between the processor and the ultrasonic transmitting terminal.

5. The touch detection and feedback system of claim 4, wherein the feedback output element is a piezoelectric motor; and wherein the main control unit further comprises:
a piezoelectric motor drive chip electrically connected between the processor and the piezoelectric motor.

6. A touch detection and feedback method, which is applied to the touch detection and feedback system of claim 1, comprising:
transmitting, by the ultrasonic transmitting terminal, ultrasonic signals;
receiving, by the ultrasonic receiving terminal, the ultrasonic signals reflected from the housing; and
controlling, according to different amplitudes of the received ultrasonic signals, the feedback output element to output different feedback signals.

7. The touch detection and feedback method of claim 6, wherein the feedback output element is a piezoelectric motor; and wherein controlling, according to different amplitudes of the received ultrasonic signals, the feedback output element to output different feedback signals comprises:
if the amplitude of the received ultrasonic signal is greater than a first preset threshold, controlling the piezoelectric motor not to generate a vibration signal;
if the amplitude of the received ultrasonic signal is less than the first preset threshold and greater than a second preset threshold, controlling the piezoelectric motor to generate a first vibration signal; and
if the amplitude of the received ultrasonic signal is less than the second preset threshold, controlling the piezoelectric motor to generate a second vibration signal.

8. The touch detection and feedback method of claim 6, wherein the feedback output element is a piezoelectric motor; and wherein controlling, according to different amplitudes of the received ultrasonic signals, the feedback output element to output different feedback signals comprises:
controlling, based on a corresponding relationship between the amplitude of the ultrasonic signal and a driving voltage of the piezoelectric motor when the amplitude of the received ultrasonic signal changes, the piezoelectric motor to generate a corresponding vibration signal.

9. The touch detection and feedback method of claim 6, wherein receiving, by the ultrasonic receiving terminal, the ultrasonic signals reflected from the housing comprises:
controlling an analog-to-digital conversion channel to be turned on;
receiving, through the analog-to-digital conversion channel, the ultrasonic signal collected by the ultrasonic receiving terminal; and
controlling the analog-to-digital conversion channel to be turned off.

10. The touch detection and feedback method of claim 6, wherein controlling, according to different amplitudes of the received ultrasonic signals, the feedback output element to output different feedback signals is performed after receiving, by the ultrasonic receiving terminal, the ultrasonic signals reflected from the housing is finished.
